(19) United States
(12) Patent Application Publication
(10) Pub. No.: US 2007/0203805 A1
(43) Pub. Date: Aug. 30, 2007

(54) Method for designing and constructing a residence for a customer

(76) Inventors: Todd A. Ruhe, Dublin, OH (US); Brent C. Racer, Columbus, OH (US)

Correspondence Address: ALAN J. ROSS, ESQ, SUITE 1500, 1375 EAST NINTH ST., CLEVELAND, OH, 44114, US

(21) Appl. No.: 11/351,901

(22) Filed: Feb. 10, 2006

(51) Int. Cl. G06Q 30/00

(52) U.S. Cl. 705/27

(57) ABSTRACT

A method for designing and constructing a residence in a geographical area for a customer, wherein the customer receives a completed residence design and a bidding process without charge. The customer is provided a database of residential construction products by a service provider. The customer chooses a residential product package from for use in constructing the home. The customer notifies the service provider which products are chosen to be used in the completed residence design. The customer meets with a residential designer to develop a residential design, which includes a set of blueprints and a specification manual and includes the product package. The customer agrees that all of the residential construction products that are placed in the residence will be purchased directly from the service organization. The completed blueprints and specifications manual are provided to subscribing residential construction contractors who agree to purchase the various construction products only from the service organization. Bids are obtained from these contractors, which can be reviewed and compared against one another.

### BACKGROUND OF THE INVENTION

An individual or married couple considering constructing a new custom home must deal with a great number of issues. There is no simple, cost effective way to obtain full project comparable bids from residential contractors. Even if an architect is consulted and a home designed from scratch, it is still usually not possible to obtain full project comparable bids. The drawings and specification often leave many decisions to the construction process, and the use of allowances to avoid specific design and product choices until after construction is begun is ubiquitous in the residential construction business.

In addition, many individuals and couples cannot afford the services of an architect and must depend upon a builder for both the design and construction of the residence. This limits the choices available for the design of the residence and ensures that many design and product decisions will be left until construction, when the available choices will be even more limited. It also negates the potential cost savings inherent in obtaining full project comparable bids from multiple contractors.

The uninformed home buyer is usually ill prepared to prevent costly overruns, and is unfamiliar with construction methods and practices. As such, it is easy for the new home buyer to fall prey to inflated costs, miscommunications and delays.

Accordingly, a need exists for a method that enables a home buyer to obtain a custom design for his or her home that includes a complete set of residential design blueprints and a specification manual that eliminates or at least minimizes the use of design-driven allowances and sets forth complete design and product choices, that obtains comparable full project bids from qualified residential contractors, that simplifies the bidding process, that eliminates or at least minimizes up-front costs, that ensures quality control, and that permits the home buyer to avoid cost overruns and be assured of the final price before construction begins.

### BRIEF SUMMARY OF THE INVENTION

According to a preferred embodiment of the invention, a method is provided for designing and constructing a residence in a geographical area for a customer, wherein the customer receives a completed residence design and a bidding process without charge, comprising the steps of:
(a) Providing a database of subscribing suppliers of residential construction products, including at least one of said subscribing suppliers of at least some of windows, exterior doors, kitchen cabinets, bath cabinets, kitchen countertops, bathroom countertops, interior doors, garage doors, floor coverings, lighting fixtures, plumbing fixtures, landscaping, outdoor lighting, and interior room trim;
(b) Providing a second database of residential construction products supplied by each of said subscribing suppliers, including one or more of at least some of said windows, exterior doors, kitchen cabinets, bath cabinets, kitchen countertops, bathroom countertops, interior doors, garage doors, floor coverings, lighting fixtures, plumbing fixtures, landscaping, outdoor lighting, and interior room trims;
(c) Providing a third database of said subscribing residential contractors, wherein said subscribing residential contractors include a plurality of contractors that construct residences in said geographical area and which agree to purchase the residential construction products chosen by the customer;
(d) Exhibiting to the customer at least some of said residential construction products, including one or more of the at least some of said windows, exterior doors, kitchen cabinets, bath cabinets, kitchen countertops, bath countertops, interior doors, garage doors, floor coverings, lighting fixtures, plumbing fixtures, landscaping, outdoor lighting, and interior room trims;
(e) Aiding the customer in choosing a design package for the residence, said design package including a residential product package, comprised of at least one of each of the at least some of said residential construction products, including at least one of each of the at least some of said windows, exterior doors, kitchen cabinets, bath cabinets, kitchen countertops, bath countertops, interior doors, garage doors, floor coverings, lighting fixtures, plumbing fixtures, landscaping, outdoor lighting, and interior room trims;
(f) Preparing the completed residence design, wherein the completed residence design includes the residential product package and a full set of residence construction documents, including a set of blueprints and a specification manual;
(g) Presenting said completed residence design to the customer for approval;
(h) Presenting said completed residence design to bidding contractors, comprising at least some of the subscribing residential contractors, wherein said bidding contractors participate in the bidding process;
(i) Obtaining from each of said bidding contractors a bid price to construct the residence substantially in accordance with the completed residence design;
(j) Reviewing with the customer the price obtained from said bidding contractors;
(k) Aiding the customer in choosing the residential construction contractor from the bidding contractors to construct the residence substantially in accordance with the completed residence design, substantially for said price;
(l) Providing the residential product package to the residential construction contractor; and
(m) Receiving payment for the residential product package.

Alternate embodiments of the invention may include the use of an independent architect or designer to prepare the blueprints, the presentation of alternative designs by the residential designer, the modification of the blueprints or specification manual after one or even several meetings with the home buyer, the preparation of a competitive bid analysis after receipt of prices from the bidding contractors, conducting interviews of the bidding contractors, receiving payment directly from the customer or from the residential contractor for the residential product package, conducting quality assurance walk-throughs during construction of the home, and answering questions from the home buyer during construction.

### BRIEF DESCRIPTION OF THE DRAWINGS

These and other features of the invention are more fully set forth in the following description of presently preferred embodiments of the invention. The description is presented with reference to the accompanying drawings in which:

FIG. 1a through 1c are diagrams of the prior art methods of designing and constructing a home; and

FIG. 2 is diagram of the method according to one embodiment of the invention.

### DETAILED DESCRIPTION OF PREFERRED EMBODIMENTS

According to a preferred embodiment of the invention, an inexperienced home buyer can obtain a design of a custom home from a residential designer, avoid the use of allowances by including all necessary product designs, such as cabinets, floor coverings, doors and windows, in the design, obtain bids from experienced residential building contractors in the geographic area in which the home will be situated, enter into a contract with a fixed price, and build the house, all while making no payment for residential design, only the residential building contractor as the home is built.

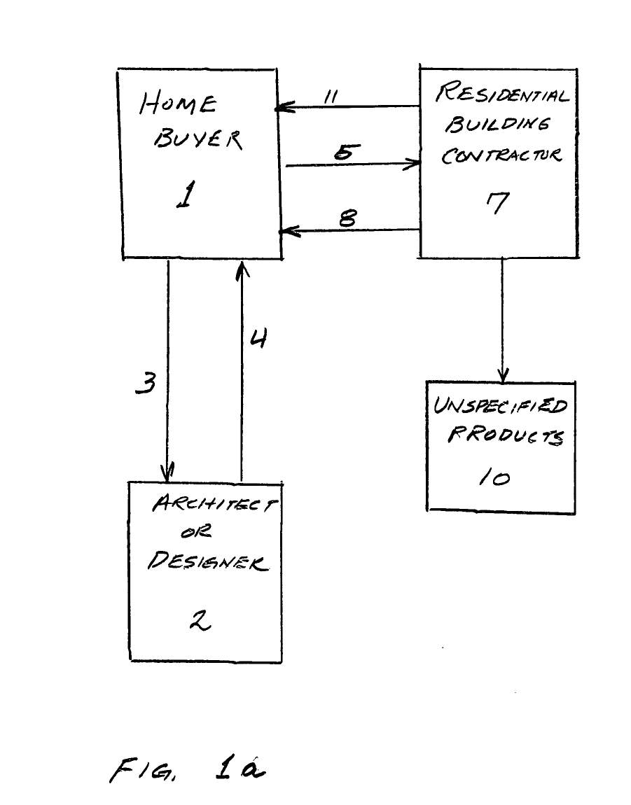

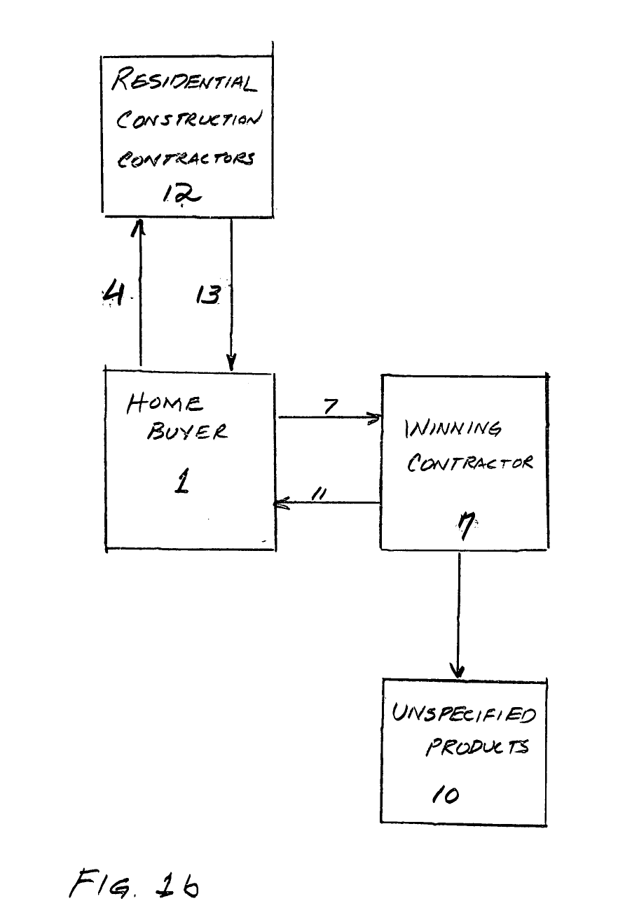

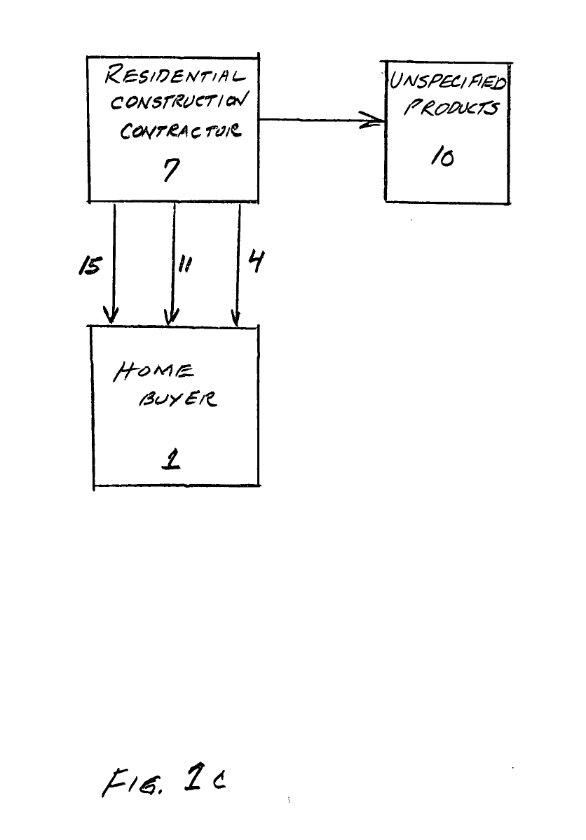

As shown in FIG. 1a through 1c, the prior art methods of building a custom designed home do not permit the home-buyer to achieve the same level of design flexibility, while securing a fixed price and eliminating cost overruns during construction. FIG. 1a illustrates the typical prior art method of obtaining construction of a custom-designed home. First, a potential home-buyer 1 approaches an architect or designer experienced in residential design 2. A contract is signed 3, requiring the home-buyer to make payment for the design, typically in several installments, with the cost of the design rising with each meeting between the architect and the home-buyer. Typically, several meetings take place, while the architect deciphers the home-buyers desires and makes changes to the home design. At the conclusion of the design phase of the process, the home-buyer is provided with a set of blueprints 4 that reflect the architect's vision of the home-buyer's desires.

The home-buyer then provides 5 those blueprints to a residential building contractor 7 which provides an estimate of the cost 8 to construct the residence. That estimate is typically replete with what are known as allowances, which are estimates of cost for unspecified products 10 that will be placed in the residence during construction. Those products may include floor coverings, cabinets, windows, doors, lighting fixtures, countertops, and plumbing fixtures, to name just a few. The actual products are not chosen until construction is well underway. Thus, the contractor is required to assume a certain level of quality and quantity at the time the estimate of cost is prepared. If the customer decides that a higher level of quality or different quantities are necessary, the cost increases at the time of construction in the form of a change order 11.

As an alternative approach, the home-buyer 1 may decide to put the residential construction contract up for bid among several contractors 12. A shown in FIG. 1b, the home-owner distributes copies of the blueprints 4 to several residential construction contractors 12, who each submit a bid 13 for the cost of construction to the home-owner. The home-owner then reviews the bids, alone or in conjunction with an architect or other assistant familiar with residential construction at a cost, and determines which of the contractors 12 to award 14 the contract for the construction of the residence. This process does not, however, avoid the problems described above. Each contractor will likely assume different allowances for different products and often will not include those allowances as other than a lump sum in the bid submitted for the project. As a result, the home-owner is left to compare bids that are not comparable, because they do not really compete for the same construction project. Moreover, the home-buyer then confronts the very same problems discussed above of cost overruns and change orders 11 due to faulty assumptions made by the contractor as to the level of quality or the quantity of the various products 10 that will be placed in the residence during construction.

One approach that has evolved over time in the prior art in an attempt to minimize these problems, as well as to avoid the cost of design by an architect, is illustrated in FIG. 1c. The problem is not avoided, however. In this approach, the homeowner 1 goes directly to the residential construction contractor 7. The contractor prepares a set of blueprints 4, typically one of a limited number of available designs. The contractor quotes a price 15 and, upon agreement with the home-buyer, constructs the residence in accordance with those blueprints. In these situations, the contractor still typically relies upon allowances. Thus, as products are chosen from the unspecified products 10, change orders typically ensue 11 and the price increases. Moreover, using this approach exacerbates other problems. Design choices are typically limited due to the generally narrow range of designs available to the contractor, and the ability to use competition through the bidding process to lower construction costs is lost, resulting in a higher priced home.

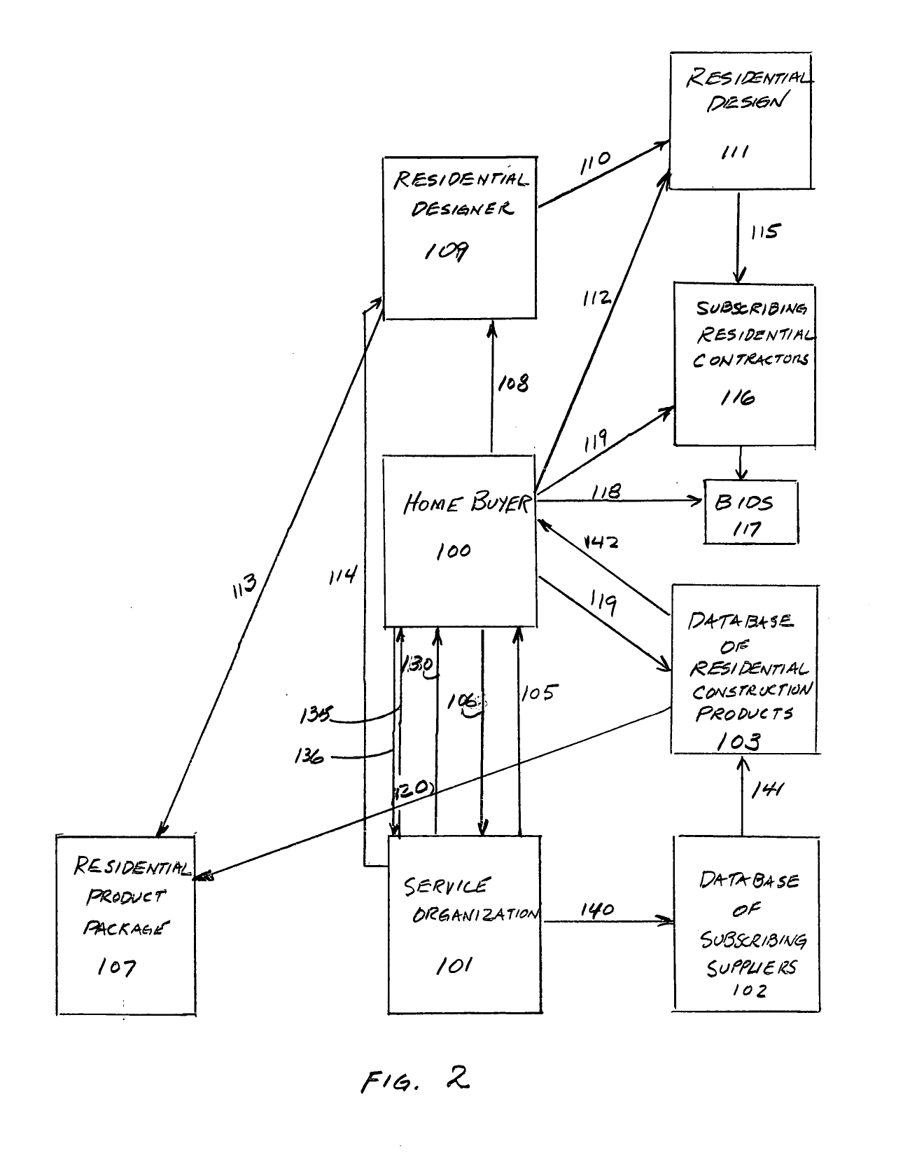

All of these problems and others are avoided or minimized by the invention, a preferred embodiment of which is illustrated in FIG. 2. In accordance with the preferred embodiment, a database of subscribing suppliers of residential construction products 102, i.e., products that are necessarily used in a residence, is provided 140 by a service organization 101. These products, contained in the database 141, might include, for illustrative purposes and not for purposes of limitation, windows, exterior doors, kitchen cabinets, bath cabinets, kitchen countertops, bathroom countertops, interior doors, garage doors, floor coverings, lighting fixtures, plumbing fixtures, landscaping, outdoor lighting, and interior room trim. There may be only one supplier for each type of product or there may be several such suppliers, preferably at different quality levels.

The home-buyer 100, also know as the customer, is provided 142 a catalog, i.e., a database, 103 of these residential construction products by a service organization 101. The home-buyer then reviews 119 the residential construction products 103, and chooses 120 a residential product package 107 from the residential construction products for use in constructing the home. Aid 105 may be provided to the home-buyer 100 by the service organization 101 so that he or she can understand the differences in quality of the various products 103, the benefits offered by the products 103, and their cost. In this way, the problem of allowances is avoided, since the home-buyer must notify 106 the service provider in advance precisely which products are chosen from the residential construction products to be used in the completed residence design. These various products, as chosen by the home-buyer, become the product package for the home 107. The home-buyer then meets 108 with a residential designer 109, with or without the aid of the service provider 101, and works with the residential designer to develop a residential design 111. The residential design may include a floor plan design and exterior designs, to name a few. The residential designer may meet with the home-buyer on several occasions, fine tuning the residential design in accordance with the home-buyer's desires. At the conclusion of these meetings, the residential designer has created 110 a completed residential design 111, which includes a set of blueprints and a specification manual, which is approved 112 by the home-buyer and, because of the inclusion 113 of the product package 107 in the design, will permit the residence to be built with very little, and preferably no, reliance on allowances.

The home-buyer does not pay directly for the services of the residential designer. Instead the home-buyer agrees that all of the residential construction products placed in the residence will be purchased directly from the service organization 101 with whom the suppliers of these products have subscribed. In other words, the service organization 101 acts as a sales agent for the suppliers and in turn pays 114 the residential designer for the residential design encompassed in the blueprints and specification manual 111. In this way, the home-buyer obtains a custom design 111 for a residence without advancing any funds for the design.

The completed blueprints and specifications manual 111 are then provided 115 to subscribing residential construction contractors 116 experienced in the geographical area in which the home-buyer desires to build. These subscribing residential contractors agree in advance that they will purchase the various construction products provided by subscribing suppliers only from the service organization. Bids 117 are obtained from participating residential construction contractors who agree to bid on the residential construction project. The bids can then be reviewed and compared 118 against one another, with or without the aid of the service organization 101, and the home-buyer can rest assured that he or she is getting full project comparable bids, because the opportunity for allowances has been eliminated or at least greatly minimized.

Once the bids have been received, it is a relatively simple matter to review and compare the bids 118 and ascertain which is the best. The opportunity exists to meet 119 with the bidders, discuss their bids, and consider factors other than cost. Aid 130 can be provided to the home-buyer considering which residential contractor to choose.

Once construction commences, the service organization provides the various products in the product package 135 and receives remuneration 136 either directly from the home-buyer 100, or from the residential construction contractor 116 chosen as the winning bidder. During construction of the residence, the service organization 101 may also act as an advisor to the home-buyer 100, providing walk-throughs of the residence under construction, answering questions, and generally acting as an advisor to the home-buyer.

There are many variations on this theme available to one of skill in the art. The organization providing these services may elect to include its own residential design services. The service organization 101 may choose to offer its own residential construction products 103, either with other residential construction products or exclusively. The service organization 101 may choose to computerize all or some of the databases of subscribing suppliers 102, products

We claim:

1. A method for designing and constructing a residence in a geographical area for a customer, wherein the customer receives a completed residence design and a bidding process without charge, comprising the steps of:
(a) Providing a database of subscribing suppliers of residential construction products, including at least one of said subscribing suppliers of at least some of windows, exterior doors, kitchen cabinets, bath cabinets, kitchen countertops, bathroom countertops, interior doors, garage doors, floor coverings, lighting fixtures, plumbing fixtures, landscaping, outdoor lighting, and interior room trim;
(b) Providing a second database of residential construction products supplied by each of said subscribing suppliers, including one or more of at least some of said windows, exterior doors, kitchen cabinets, bath cabinets, kitchen countertops, bathroom countertops, interior doors, garage doors, floor coverings, lighting fixtures, plumbing fixtures, landscaping, outdoor lighting, and interior room trims;
(c) Providing a third database of said subscribing residential contractors, wherein said subscribing residential contractors include a plurality of contractors that construct residences in said geographical area and which agree to purchase the residential construction products chosen by the customer;
(d) Exhibiting to the customer at least some of said residential construction products, including one or more of the at least some of said windows, exterior doors, kitchen cabinets, bath cabinets, kitchen countertops, bath countertops, interior doors, garage doors, floor coverings, lighting fixtures, plumbing fixtures, landscaping, outdoor lighting, and interior room trims;
(e) Aiding the customer in choosing a design package for the residence, said design package including a residential product package, comprised of at least one of each of the at least some of said residential construction products, including at least one of each of the at least some of said windows, exterior doors, kitchen cabinets, bath cabinets, kitchen countertops, bath countertops, interior doors, garage doors, floor coverings, lighting fixtures, plumbing fixtures, landscaping, outdoor lighting, and interior room trims;
(f) Preparing a completed residence design, wherein the completed residence design includes the residential product package and a full set of residence construction documents, including a set of blueprints and a specification manual;
(g) Presenting said completed residence design to the customer for approval;
(h) Presenting said completed residence design to bidding contractors, comprising at least some of the subscribing residential contractors;
(i) Obtaining from each of said bidding contractors a price to construct the residence substantially in accordance with the completed residence design;
(j) Reviewing with the customer the price obtained from said bidding contractors;
(k) Aiding the customer in choosing the residential construction contractor from the bidding contractors to construct the residence substantially in accordance with the completed residence design, substantially for said price;
(l) Providing the residential product package to the residential construction contractor; and
(m) Receiving payment for the residential product package.

2. The method of claim 1, further comprising providing the completed residence design to an independent designer for preparation of the completed residence design.

3. The method of claim 1, further comprising modifying the completed residence design after meeting with the customer.

4. The method of claim 1, further comprising preparing a comparative bid analysis of the prices received from the bidding contractors.

5. The method of claim 1, further comprising conducting an interview of the bidding contractors.

6. The method of claim 1, further comprising presenting alternative designs to the customer.

7. The method of claim 1, further comprising answering one or more questions from the customer during construction of the residence.

8. The method of claim 1, further comprising ensuring that the residential construction contractor constructs the residence in accordance with the completed residence design.

9. The method of claim 1, further comprising charging a fee to the customer for failing to include certain of the residential construction products in the residential product package.

10. A method for designing and constructing a residence in a geographical area for a customer, wherein the customer receives a completed residence design and a bidding process without charge, comprising the steps of:
(a) Providing a database of subscribing suppliers of residential construction products, including at least one of said subscribing suppliers of at least some of windows, exterior doors, kitchen cabinets, bath cabinets, kitchen countertops, bathroom countertops, interior doors, garage doors, floor coverings, lighting fixtures, plumbing fixtures, landscaping, outdoor lighting, and interior room trim;
(b) Providing a second database of residential construction products supplied by each of said subscribing suppliers, including one or more of at least some of said windows, exterior doors, kitchen cabinets, bath cabinets, kitchen countertops, bathroom countertops, interior doors, garage doors, floor coverings, lighting fixtures, plumbing fixtures, landscaping, outdoor lighting, and interior room trims;
(c) Providing a third database of said subscribing residential contractors, wherein said subscribing residential contractors include a plurality of contractors that construct residences in said geographical area;
(d) Exhibiting to the customer at least some of said residential construction products, including one or more of the at least some of said windows, exterior doors, kitchen cabinets, bath cabinets, kitchen countertops, bath countertops, interior doors, garage doors, floor coverings, lighting fixtures, plumbing fixtures, landscaping, outdoor lighting, and interior room trims;
(e) Aiding the customer in choosing a design package for the residence, said design package including a residential product package, comprised of at least one of each of the at least some of said residential construction products, including at least one of each of the at least some of said windows, exterior doors, kitchen cabinets, bath cabinets, kitchen countertops, bath countertops, interior doors, garage doors, floor coverings, lighting fixtures, plumbing fixtures, landscaping, outdoor lighting, and interior room trims;
(f) Preparing a completed residence design, wherein the completed residence design includes the residential product package and a full set of residence construction documents, including a set of blueprints and a specification manual;
(g) Presenting said completed residence design to the customer for approval;
(h) Presenting said completed residence design to bidding contractors, comprising at least some of the subscribing residential contractors;
(i) Obtaining from each of said bidding contractors a price to construct the residence substantially in accordance with the completed residence design;
(j) Reviewing with the customer the price obtained from said bidding contractors;
(k) Aiding the customer in choosing the residential construction contractor from the bidding contractors to construct the residence substantially in accordance with the completed residence design, substantially for said price;
(l) Providing the residential product package to the residential construction contractor; and
(m) Receiving payment for the residential product package from the residential construction contractor.

11. The method of claim 10, further comprising providing the completed residence design to an independent designer for preparation of the completed residence design.

12. The method of claim 10, further comprising modifying the completed residence design after meeting with the customer.

13. The method of claim 10, further comprising preparing a comparative bid analysis of the prices received from the bidding contractors.

14. The method of claim 10, further comprising conducting an interview of the bidding contractors.

15. The method of claim 10, further comprising conducting a quality assurance walk-through while constructing the residence

16. The method of claim 10, further comprising answering one or more questions from the customer during construction of the residence.

17. The method of claim 10, further comprising presenting alternative designs to the customer.

18. The method of claim 10, further comprising ensuring that the residential construction contractor constructs the residence in accordance with the completed residence design.

19. The method of claim 10, further comprising charging a fee to the customer for failing to include certain of the residential construction products in the residential product package.
